(19) United States
(12) Patent Application Publication
(10) Pub. No.: US 2012/0246323 A1
(43) Pub. Date: Sep. 27, 2012

(54) MECHANISM FOR ADAPTIVELY CHOOSING UTILITY COMPUTING APPLICATIONS BASED ON NETWORK CHARACTERISTICS AND EXTENDING SUPPORT FOR ADDITIONAL LOCAL APPLICATIONS

(76) Inventors: Vinod Kumar Gopinath, Chennai (IN); Badrinath Sriram, Chennai (IN); Venu Gopalraju Kanumuri, Chennai (IN); Siva Rama Krishna Reddy, Chennai (IN); Yuri Sysoyev, Chennai (IN)

(21) Appl. No.: 13/513,333

(22) PCT Filed: Nov. 30, 2010
(86) PCT No.: PCT/IN2010/000773

§ 371 Date: Jun. 1, 2012

(30) Foreign Application Priority Data
Dec. 2, 2009 (IN) 2970/CHE/2009

(51) Int. Cl. G06F 15/173

(52) U.S. Cl. 709/226

(57) ABSTRACT

A system and method for adaptively choosing applications/utilities can be provided to users in a cloud based utility computing environment (VCE) based on their network characteristics. Methods categorize remote utility computing applications (RAPPs) based on their network Quality of Service (QOS) requirements. Methods decide on suitable RAPPs that can be provided to users based on their network parameters, measured in the network path between users and the nearest utility computing server farm. A local hard disk based operating system and application can be provided, which is not a managed environment, but the access to which is controlled by the utility computing environment.

### FIELD OF INVENTION

The present invention relates to a system and method for adaptively choosing applications/utilities that can be provided to users in a cloud based utility computing environment (UCE) based on their network characteristics. More specifically the present invention deals primarily with methods to categorize remote utility computing applications (RAPPS) based on their network Quality of Service (QOS) requirements. It also deals with methods to decide on suitable RAPPS that can be provided to users based on their network parameters, measured in the network path between users and the nearest utility computing server farm. The invention also deals with the ability to provide local hard disk based operating system and application which is not a managed environment but the access to which is controlled by the utility computing environment.

### BACKGROUND

The users of a UCE access some of their computing requirements dynamically. The computing requirements are not necessarily locally resident but are usually accessed across a network. The user uses the resource for the required time and releases these on completion. Thus the resources in this system are shared between a set of users. Thus resource optimization and hence cost optimization is achieved for the customers and the different players in the UCE.

To realize the above mentioned objectives, utility computing utilizes a number of components that provide computing to users, manage the usage and features requested by users and monitor and manage the different physical components in the environment. These components are spread over the three physical components in the environment, viz. a simple interface device at the users end usually referred to as a network computer (NC), a server farm and the network that connects these two components.

The NC is an embedded device or a network based computing device that is capable of running local and remote applications. This device connects to a server farm to access the complex and native applications required by the user. The features in the NC are configurable and are dynamically managed by the server. The server consists of two components. One component provides the features and functionality required by the users. The other component manages the complete environment. The network includes the physical network and the protocols that the client and servers use to communicate with each other.

### DESCRIPTION OF THE PRIOR ART

There is little evidence in UCEs, where choosing of RAPPs is adaptively done based on the network characteristics. Listed below are some problems related to current methods of choosing RAPPs for UCEs.

### PROBLEMS OF THE PRIOR ART

1. In the existing NC based environments, the delivery of RAPPs is done by delivery of the whole desktop from the server through protocols like Remote Desktop Protocol, X Protocol etc. So all applications from multimedia to productivity applications are executed on the server and streamed to the client. This would mean that the network requirements for streaming of applications are heavy. The network between the server and user's premises should be commissioned for the maximum network required (mainly bandwidth). So regardless of the application's network requirements a higher requirement is placed to ensure that all applications are usable. For example, the usage of browser for multimedia content requires a high bandwidth network whereas the bandwidth requirement for productivity applications like text editors is much lower. But since both these applications run on a server they require to be connected to the NC on a high bandwidth network to ensure that both the applications run well. Even if the NC is in a place where the available bandwidth is low but still high enough for some low bandwidth remote applications, current models do not allow this. The current models permit NCs to be installed only if the available bandwidth is able to satisfy the need of all remote applications. Thus the reach of a UCE based on NCs is dependant heavily on the availability of high bandwidth and consistent networks. Hence NC is unable to use those UCE RAPPs which require very little bandwidth.
2. In current UCEs, the RAPPs are chosen statically, primarily based on what comes bundled along with the remote Desktop OS, without regard to their individual QOS requirements.
3. Also, in current UCEs, RAPPs, are not chosen based on network characteristics of individual NCs. For example, a NC having a 256 Kbps plan and a NC having a 512 Kbps plan would be provided with the same set of RAPPs.
4. Also while choosing the set of RAPPs, only the maximum provisioned downstream bandwidth requirement of the last mile network is taken into account. Other vital network parameters like the actual available downstream bandwidth (available bandwidth may vary every instant based on congestion in the network and is usually less than the provisioned bandwidth), available upstream bandwidth, downstream/upstream latency (delay) and upstream/downstream packet loss percentage (percentage of packets dropped in the network due to congestion) are not considered.
5. The network parameters may vary from time to time based on congestion in the network and also NC users may upgrade their ISP plans. Current UCEs do not dynamically and adaptively change (upgrade/downgrade) the list of RAPPs based on the recent statistics of users.
6. After providing a list of RAPPs, UCEs do not provide a dynamic network monitoring facility to NC users about their instantaneous network characteristics (downstream/upstream available bandwidth, latency and packet loss). Such a facility would help NC users to find out problems in their network connectivity, especially during times when they face problems with RAPPs. In such situations, they might be wrongly thinking that the problem is in the server farm.
7. There are very few end to end UCE setups available in the current scenario. Most of them offer applications over the cloud that can be accessed on a personal computer through a browser. Few of them actually offer an end user device which is mostly a highly controlled thin client. In these cases, the user does not have the ability to get applications other than what is offered by the UCE provider. If the user wants his/her own application, there is no way to get it unless the service provider offers it, which is a time consuming if not impossible process. There is no possibility for the user to have his/her own controlled environment along with frequently used maintenance-free, totally managed, and guaranteed computing environment (the UCE).

Several prior arts related to management of the network characteristics in computing environment are discussed hereunder.

EP1232610 relates to bandwidth management in a communication network. It details how to provide dynamic bandwidth management on a per subscriber basis in a generic network computing environment. The present invention deals with changing the set of applications based on the available network in a utility computing environment.

U.S. Pat. No. 7,565,445 deals with categorizing the network traffic by dynamically determining the characteristics of the network traffic. The network characteristics like bandwidth and latency which are measured in the present invention is used to determine the types of remote applications that can be provided to utility computing device.

US2008101460 and WO0078031 disclose how network can be assigned to users based on their application of user, pricing information, etc. The present invention provides appropriate applications to the users based on the network conditions, thereby giving an optimal performance for the user based on his/her network conditions.

WO2006098825 describes a system and method for dynamically estimating the bandwidth in a wireless network which at least has one client. The system estimates the bandwidth required and then adjusts the network such that the client and application receives the required bandwidth. The present invention provides local and remote applications based on the bandwidth available.

WO2008059535 deals with managing the users and other entities in a utility computing environment. In the present invention the applications are spread across different servers and the access to the application depends on the network conditions between the server farm and the utility computing client device.

Thus there exist a need for a system and a method for adaptively choosing applications/utilities that can be provided to users in a cloud based utility computing environment (UCE) based on their network characteristics and also that avoids the problems/disadvantages noted above.

### OBJECTS OF THE INVENTION

One or more of the problems of the conventional prior art may be overcome by various embodiments of the present invention. The primary object of the present invention is directed to a system and method for adaptively choosing applications/utilities that can be provided to users in a cloud based utility computing environment (UCE) based on their network characteristics.

It is another object of the present invention to provide a system and method of providing remote utility computing applications (RAPPS) to utility computing environment (UCE) users based adaptively on their network characteristics.

It is another object of the invention to provide a method to categorize the remote utility computing applications (RAPPS) based on their network Quality of Service (QOS) requirements.

It is another object of the invention, wherein the RAPPs are classified based on one or more combination of the following six network parameters:
Mean available downstream bandwidth requirement;
Mean available upstream bandwidth requirement;
Mean downstream latency;
Mean upstream latency;
Downstream packet loss tolerance; and
Upstream packet loss percent tolerance

It is another object of the present invention to provide a system and method for adaptively choosing applications/utilities that can be provided to users in a cloud based utility computing environment (UCE) based on their network characteristics, wherein the available downstream/upstream bandwidths are used instead of the provisioned ones for Rapp's classification and choosing purposes.

It is yet another object of the present invention, wherein the method is adapted to separately measure one-way latencies in the upstream and downstream directions from the NC to the UCE server farm.

It is yet another object of the present invention, wherein the QOS requirements with respect to the six network parameters vary considerably between RAPPs.

It is another object of the present invention to provide a system and method for adaptively choosing applications/utilities that can be provided to users in a cloud based utility computing environment (UCE) based on their network characteristics, wherein based on the list of RAPPs available at the UCE and their respective QOS, the UCE administrators can categorize these applications into multiple categories.

It is another object of the present invention, wherein the RAPPs could also be categorized based on the QOS characteristics available to a majority of UCE customers.

It is another object of the present invention, wherein the NC is connected to the outer world through a variety of networks the QOS of which may vary from NC to NC.

It is another object of the invention, wherein for the same NC, the network characteristics may vary from time to time.

It is another object of the present invention, wherein the primary parameters that are tracked for a NC are the downstream/upstream available bandwidth (not provisioned bandwidth), downstream/upstream one-way latency and downstream/upstream packet loss percentage in the network between the NC and the UCE server farm.

It is another object of the present invention, wherein standard tools are available for measuring all the six parameters (available upstream/downstream bandwidth, upstream/downstream latency, and upstream/downstream packet loss percentage).

It is another object of the present invention, wherein the six network parameters are periodically measured between the NC and UCE. To calculate the mean values of these parameters, a moving average method is used, where different weights may be given to past and current readings.

It is another object of the present invention to have the periodicity of measurement of each network parameter dynamically configurable from the server farm any time.

It is another object of the present invention, wherein the list of RAPPs made available to the user by the UCE would be done based on the recent values of the moving averages of these parameters.

It is another object of the present invention, wherein the list of RAPPs is arrived by comparing the respective values of the NC's network parameters and the QOS requirements of each RAPP.

It is another object of the present invention, wherein the NC keeps track of the network characteristics it has to its nearest server farm and periodically reports it to the server farm.

It is another object of the present invention, wherein an application server running in the server farm would dynamically inform NC users about the list of RAPPs that the user can access, based on recent values of network parameters.

It is another object of the present invention, wherein for each network parameter, the comparison can be made against a range of values rather than an exact value.

It is another object of the present invention, wherein the list of RAPPs made available to the NC may additionally depend on the time of the day.

It is another object of the present invention, wherein since the network parameters are periodically measured and since the moving averages are recalculated every time, the set of RAPPs made available to the NC user can be dynamically adapted to his/her recent network characteristics.

It is another object of the present invention, wherein the users of the UCE could be classified into different classes based on their moving average values of QOS parameters.

It is another object of the present invention to display to the NC user, information about his/her current network parameters.

It is another object of the present invention, wherein the information can be used by NC users to gauge their ISPs service levels as well as to upgrade their ISP plans.

It is another object of the present invention, wherein the browser on the UCE client end device accesses a number of different types of websites on the Internet. These sites stream different types of media and content to the browser.

It is another object of the present invention, wherein the NC users would be able to use some RAPPs even if they do not have a high bandwidth connection.

It is another object of the present invention, wherein the users can work with additional applications that are not a provided by the UCE. In this case, the UCE customer end device has the ability to include a hard disk.

It is another object of the present invention, wherein the UCE required client software is available in a separate secure disk, which is not accessible to the user directly. The following are the areas in which the software is stored:
The UCE client side software is resident on secure storage like a Disk on Module or Flash and the user desired OS and applications are resident on a Hard disk or USB based storage.
The UCE client side software is resident on a secure partition in a hard disk and the user desired OS and applications are also resident on different partitions on the hard disk.

It is another object of the present invention, wherein the user can use the hard disk as a storage that is accessible from the UCE or install an operating system.

It is another object of the present invention, wherein the hard disk environment is not managed by the UCE but the access to the hard disk is controlled by the UCE.

It is another object of the present invention, wherein when the client end device boots up, it directly boots into the UCE and an icon on this environment lets the user get into the hard disk operating system.

It is another object of the present invention, wherein the switching between the UCE and hard disk OS is done using a quick switch system.

It is another object of the present invention, wherein the method of switching includes:
1. Both the UCE and hard disk are hibernated onto the hard disk and the switching happens from this hibernated image.
2. In this system, a small layer starts off which decides whether the hard disk OS is allowed to boot or the UCE should start. This layer is called the Execution Abstraction Layer (EAL). The UCE system runs on top of the EAL. The EAL has the responsibility of keeping both the system alive at the same time and switching between one and the other as requested by the user. The EAL controls that the running system (hard disk OS or UCE) gets the complete system resource and that there is only a minimal compromise due to the EAL.

### SUMMARY OF THE INVENTION

Thus according to the basic aspect of the present invention there is provided a method for adaptively choosing, categorizing and providing applications/utilities to the users in a cloud based utility computing environment (UCE) based on their network characteristics measured in the network path between users and the nearest utility computing server farm comprising:

classifying remote utility computing applications (RAPPs) based on their network Quality of Service (QOS) requirements;

categorizing the RAPPs available at the utility computing environment (UCE) into one or more categories;

measuring network characteristics (upstream and downstream) from the network computer (NC) to the UCE server farm;

comparing the respective values of the NC's network parameters and the QOS requirements of each RAPP to arrive at the list of eligible RAPPs for the particular NC;

choosing RAPPs for a given NC;

periodically measuring the network characteristics that the NC has to its nearest server farm and periodically reporting the network characteristics to the server farm;

dynamically adapting the eligible set of RAPPs based on the current network characteristics; and

dynamically informing the NC users about the list of RAPPs that the user can access, based on recent values of network parameters,

wherein the periodicity of measurement of each network parameter is dynamically configurable from the server farm any time,

wherein the periodicity of measurement can vary between parameters,

wherein an application server running in the server farm dynamically informs the NC users about the list of RAPPs that the user can access, based on recent values of network parameters, and

wherein the comparison is made against a range of values rather than an exact value for each network parameter.

In another aspect of the present invention there is provided a method for adaptively choosing, categorizing and providing applications/utilities to the users in a cloud based utility computing environment (UCE) based on the network characteristics measured in the network path between users and the nearest utility computing server farm, wherein the remote utility computing applications (RAPPs) are classified based on one or more combination of the following six network parameters:
Mean available downstream bandwidth requirement;
Mean available upstream bandwidth requirement;
Mean downstream latency;
Mean upstream latency;
Downstream packet loss tolerance; and
Upstream packet loss percent tolerance,

wherein the available downstream/upstream bandwidths are used instead of the provisioned ones for RAPP's classification, and

wherein one-way latencies in the upstream and downstream directions are measured from the NC to the UCE server farm.

It is another aspect of the present invention, wherein the mean values are calculated using a moving average method, wherein different weights may be given to past and present readings.

It is another aspect of the present invention, wherein the RAPPs are categorized based on the QOS characteristics available to a majority of UCE customers.

It is another aspect of the present invention, wherein the exact number of categories and the combinations of parameters for each category along with their values is not uniform and varies between UCEs.

It is another aspect of the present invention, wherein the categorization of available RAPPs for a NC is dependent on the time of the day.

In yet another aspect of the present invention there is provided a system of making available to the users applications not provided in a utility computing environment (UCE) comprising:

hard disk;

execution abstraction layer (EAL);

utility computing environment (UCE) client side software;

user desired OS; and

user desired applications,

wherein the hard disk is partitioned to have a secured partition,

wherein the UCE client side software is resident on the secured partition,

wherein the user desired OS and applications are resident on the non secured partition,

wherein the UCE does not manage the non secured hard disk environment,

wherein the user cannot access the UCE from the hard disk based OS,

wherein access to the non secured hard disk environment is provided through the UCE,

wherein the EAL provides for the user to switch between the UCE or the user desired OS for start up,

wherein the EAL keeps alive both the UCE and the user desired OS, and

wherein the EAL provides the required system resource both to the UCE and the user desired OS.

In another aspect of the present invention there is provided a system of making available to the users applications not provided in a utility computing environment (UCE) comprising:

secured hard disk;

non secured hard disk;

execution abstraction layer (EAL);

utility computing environment (UCE) client side software;

user desired OS; and

user desired applications,

wherein the secured hard disk is partitioned to have a secured partition,

wherein the UCE client side software is resident on the secured partition,

wherein the user desired OS and applications are resident on the non secured hard disk,

wherein the UCE does not manage the non secured hard disk environment,

wherein the user cannot access the UCE from the hard disk based OS,

wherein access to the non secured hard disk environment is provided through the UCE,

wherein the EAL provides for the user to switch between the UCE and user desired OS for start up,

wherein the EAL keeps alive both the UCE and the user desired OS, and

wherein the EAL provides the required system resource both to the UCE and the user desired OS.

It is another aspect of the present invention, wherein the non secured hard disk can be a USB based hard disk.

### BRIEF DESCRIPTION OF THE ACCOMPANYING FIGURES

FIG. 1: illustrates a typical utility computing environment deployment with logical functional blocks inside a thin client and a server farm according to the present invention.

FIG. 2: illustrates a sample table of a utility computing environment containing criteria for choosing different remote applications based on network parameters according to the present invention.

### DETAILED DESCRIPTION OF THE INVENTION WITH REFERENCE TO THE ACCOMPANYING FIGURES

The present invention as discussed hereinbefore relates to a system and method for adaptively choosing remote utility computing applications (RAPPS) that can be provided to users in a cloud based utility computing environment (UCE) based on their network Quality of Service (QOS) requirements. More specifically the present invention deals with methods to decide on suitable RAPPS that can be provided to users based on their network parameters, measured in the network path between users and the nearest utility computing server farm.

More specifically, UCE RAPPs are classified based on one or more combination of the following six network parameters:
Mean available downstream bandwidth requirement;
Mean available upstream bandwidth requirement;
Mean downstream latency;
Mean upstream latency;
Downstream packet loss tolerance; and
Upstream packet loss percent tolerance

Normally, the actual bandwidths got by network computer (NC) users are not always equal to the provisioned values and most of the times, the available bandwidths are lesser (sometimes significantly) than their provisioned values, due to congestion in the network. Hence, the present invention uses the available bandwidths instead of the provisioned ones for RAPP's classification and choosing purposes.

Conventional method measures the round trip time (RTT) from the end points and then divide it by two to get the downstream/upstream latencies. This assumes that the latencies are equal in both the upstream and downstream directions. But many times, this assumption is not true and there may be congestion in only one direction. Due to this factor, the method of the present invention separately measures one-way latencies in the upstream and downstream directions from the NC to the UCE server farm.

The QOS requirements with respect to the six network parameters vary considerably between RAPPs. A few examples are given below:
RAPPs like near VOD (video-on-demand) require high downstream bandwidth and low downstream latency, but do not require any strict constraint on the other 4 parameters. If it is a normal VOD, then additionally upstream latency would be crucial as users would like to pause/forward/rewind VOD content and the corresponding actions have to be seen immediately by the user. Some percentage of packet loss is tolerable for these RAPPs. RAPPs like online gaming would also require QOS characteristics similar to that of normal VOD.
RAPPs like remote text editors are interactive applications that require low downstream bandwidth (for incremental text/cursor updates), very low upstream bandwidth (for carrying typed characters/mouse movements), low downstream and upstream latency (for interactiveness) and a near zero percentage upstream and downstream packet loss.
RAPPs like small-screen news updates, mini-stock-price tickers, etc. would just require a very low downstream bandwidth, with no requirement on any other parameters
RAPPs like online picture editors, slide presentation applications would require medium downstream bandwidth, low upstream/downstream latency (for interactiveness) and low upstream packet loss percentage. Upstream bandwidth and downstream packet loss need not have strict requirements in such RAPPs.
RAPPs like remote file storage require medium upstream and downstream bandwidths but need not have strict requirements on the other 4 parameters, as they have the ability to recover from packet losses and also do not require strict bound on the latencies.

Based on the list of RAPPs available at the UCE and their respective QOS, the UCE administrators can categorize these applications into multiple categories. The exact number of categories and the combinations of parameters for each category (along with their values) can vary between UCEs and need not be uniform. RAPPs could also be categorized based on the QOS characteristics available to a majority of UCE customers. For example, an UCE may decide to categorize their RAPPs into the following six categories: Low downstream bandwidth interactive/non-interactive, medium downstream bandwidth inter-active/non-interactive, and high downstream bandwidth interactive/non-interactive.

Choosing RAPPs for a given NC: NC is connected to the outer world through a variety of networks whose QOS may vary from NC to NC. Also for the same NC, the network characteristics may vary from time to time. For example, available downstream bandwidth may be more during non-business hours. The primary parameters that are tracked for a NC are the downstream/upstream available bandwidth (not provisioned bandwidth), downstream/upstream one-way latency and downstream/upstream packet loss percentage in the network between the NC and the UCE server farm.

The present invention periodically measures the six network parameters between the NC and UCE. To calculate the mean values of these parameters, system use a moving average method, where different weights may be given to past and current readings. The periodicity of measurement can vary between parameters. For example, measuring upstream/downstream bandwidths introduce some traffic overhead and hence can be done less frequently when compared to the frequency of measuring the other 4 parameters (they do not introduce much overhead). Moreover the periodicity of measurement of each network parameter is dynamically configurable from the server farm any time.

The list of RAPPs made available to the user by the UCE would be done based on the recent values of the moving averages of these parameters. The list of RAPPs is arrived by comparing the respective values of the NC's network parameters and the QOS requirements of each RAPP. The NC keeps track of the network characteristics it has to its nearest server farm and periodically reports it to the server farm. An application server running in the server farm would dynamically inform NC users about the list of RAPPs that the user can access, based on recent values of network parameters. For each network parameter, the comparison can be made against a range of values rather than an exact value. For example, a NC having an average available downstream bandwidth between 256 Kbps and 384 Kbps may be eligible for all low bandwidth non-interactive applications.

The list of RAPPs made available to the NC may additionally depend on the time of the day. For example, some RAPPs could be made eligible only during non-business hours, as the network. QOS parameter values tend to be better during such times.

Since the network parameters are periodically measured and since the moving averages are recalculated every time, the set of RAPPs made available to the NC user can be dynamically adapted to his/her recent network characteristics. For example, if the user had recently upgraded to a higher bandwidth ISP plan, then he/she could be eligible for additional new RAPPs, as the moving averages of the recent network parameters would indicate that the user has a better set of network parameters now.

The users of the UCE could be classified into different classes based on their moving average values of QOS parameters. For example, users could be classified into three classes (A, B and C) based on the average values of available downstream bandwidth that they get.

Having given the user a set of RAPPs based on his/her immediate past network characteristics, a dynamic update of his/her current network parameters would help the user in judging the QOS that is got from the ISP at that point of time. Alternatively, instead of giving values for the current network parameters, users could be given descriptive messages about their QOS like “Network is currently: Good/tolerable/lossy/bad” etc. The criteria/formula for quantifying different levels like Good/Tolerable etc. would vary based on the class of the users (which is in turn based on their network characteristics). This information can be used by NC users to gauge their ISPs service levels as well as to upgrade their ISP plans.

Further the present invention extends this concept to the browser on the UCE client end device. The browser accesses a number of different types of websites on the Internet. These sites stream different types of media and content to the browser. Some of this content has very high requirements from the network. For example, a media streaming site would require a very high bandwidth. An agent that is built into the browser keeps track of the data that is flowing in and also refers to a data table that has record of the type of network parameters required for a particular site to suggest the user the type of experience he/she could experience. For example, for very low bandwidth the agent could put a red indicator to tell the user that the experience would be poor due to frequent buffering.

According to another aspect, the users can work with additional applications that are not provided by the UCE. The UCE customer end device has the ability to include a hard disk. The UCE required client software is available in a separate secure disk, which is not accessible to the user directly. The following are the areas in which the software is stored:
The UCE client side software is resident on secure storage like a Disk on Module or Flash and the user desired OS and applications are resident on a Hard disk or USB based storage.
The UCE client side software is resident on a secure partition in a hard disk and the user desired OS and applications are also resident on different partitions on the hard disk.

The user however can access the hard disk. He/she could simply use this hard disk as a storage that is accessible from the UCE or install an operating system. If the user installs an operating system on the hard disk then he/she can use the operating system to install and use applications that are not a part of the UCE. So for example, if the network parameters are not good enough in the region for certain applications then the user could install the applications on the hard disk and use it from there. The hard disk environment is not managed by the UCE but the access to the hard disk is controlled by the UCE. When the client end device boots up, it directly boots into the UCE and an icon on this environment lets the user get into the hard disk operating system. The user cannot access the UCE from the hard disk based OS. Further the switching between the UCE and hard disk OS is done using a quick switch system. The following switching methodologies are used:

1. Both the UCE and hard disk are hibernated onto the hard disk and the switching happens from this hibernated image.

2. A small layer starts off which decides whether the hard disk OS is allowed to boot or the UCE should start. This layer is called the Execution Abstraction. Layer (EAL). The UCE system runs on top of the EAL. The EAL has the responsibility of keeping both the system alive at the same time and switching between one and the other as requested by the user. The EAL controls that the running system (hard disk OS or UCE) gets the complete system resource and that there is only a minimal compromise due to the EAL.

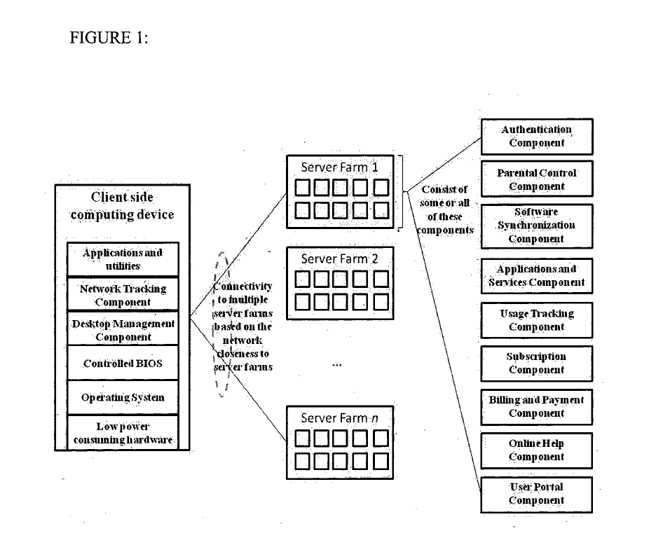

Reference is now invited to accompanying FIG. 1 that shows a typical connection between a NC and a server farm. The diagram additionally shows the different logical functional blocks of a network computer (NC) and a server farm. The functional blocks relevant to the system are the “Network Tracking” component in the NC and the “Application and Services” component in the server farm. The “Network Tracking” component consists of tools/software to measure and report the above mentioned six network parameters (upstream/downstream available bandwidth, latency and packet loss percentage).

In the preferred embodiment, the “Application and Services” component in the server farm periodically takes the measured network parameters from each NC user, calculates the moving averages of these parameters and based on these values, decides on the eligible list of RAPPs for each NC user.

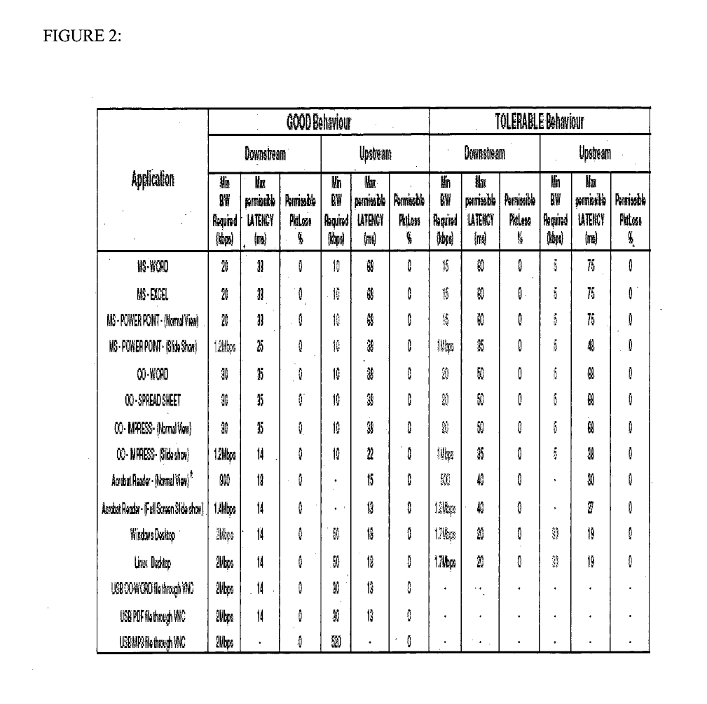

FIG. 2 shows a sample table that gives criteria/formulae for choosing different sample RAPPs based on network characteristics. For example, the first entry in the table gives eligibility criteria that could be used for the popular Windows Microsoft Word application. The table indicates that, to provide Windows Microsoft Word as a remote application to NC users, the following criteria should be met:

For “Good” behavior, the following conditions to be satisfied:
An average downstream available bandwidth of 20 Kbps AND
An average downstream latency upper bound of 38 milliseconds (ms) AND
A downstream packet loss % close to 0% AND
An average upstream available bandwidth of 10 Kbps AND
An average upstream latency upper bound of 68 ms AND
An upstream packet loss % close to 0%

For “Tolerable” behavior, the following conditions to be satisfied:
An average downstream available bandwidth of 15 Kbps AND
An average downstream latency upper bound of 60 ms AND
A downstream packet loss % close to 0% AND
An average upstream available bandwidth of 5 Kbps AND
An average upstream latency upper bound of 75 ms AND
An upstream packet loss % close to 0%

Thus the system of the invention and method thereof directed for adaptively and dynamically choosing the RAPPs that can be provided to NC users based on their network characteristics. Moreover the NC users would be able to use some RAPPs even if they do not have a high bandwidth connection. Advantageously, the present invention also deals with the ability to provide local hard disk based operating system and application which is not a managed environment but the access to which is controlled by the utility computing environment.

The details of the invention, its object, advantages and examples are explained here above is to be understood that the invention, as fully described herein is not intended to be limited by the objects mentioned herein. The described embodiments are to be considered in all respects only as illustrative and not restrictive.

1-9. (canceled)

10. A method of adaptively delivering cloud based utility services to a user device, the method comprising:
determining one or more network parameters of a network path on a periodic basis, the network path connecting the user device to a utility computing server; and
dynamically delivering one or more cloud based utility services based on the network parameters.

11. The method of claim 10, further comprising:
categorizing a plurality of available cloud based utility services based on one or more requirements for quality of service; and
determining at least one cloud based utility service to be delivered, among the plurality of available cloud based services, to the user device, based on the network parameters determined and the requirements for quality of service.

12. The method of claim 10, wherein the network parameters comprise mean available upstream bandwidth, mean available downstream bandwidth, mean downstream latency, mean upstream latency, downstream packet loss tolerance and upstream packet loss tolerance.

13. A method of adaptively delivering one or more services in a cloud based utility computing environment, the method comprising:
categorizing a plurality of cloud based utility services based on one or more requirements for quality of service;
determining network characteristics of a network path, the network path connecting a network computer to a utility computing server; and
dynamically determining a list of eligible cloud based utility services based on the network characteristics and the requirements for quality of service.

14. The method of claim 13, wherein categorizing the cloud based utility services comprises:
identifying a list of available cloud based utility services;
determining one or more requirements for quality of service for each of the available cloud based services; and
classifying the list of available cloud based utility services based on the requirements for quality of service.

15. The method of claim 13, wherein determining the network characteristics comprises:
periodically measuring one or more network parameters of a network path connecting the user device to a utility computing server; and
calculating the network characteristics based on mean values of the network parameters.

16. The method of claim 15, wherein periodically measuring comprises:
measuring a first network parameter based on a first periodicity; and
measuring a second network parameter based on a second periodicity.

17. The method of claim 15, wherein the network parameters comprise mean available upstream bandwidth, mean available downstream bandwidth, mean downstream latency, mean upstream latency, downstream packet loss tolerance and upstream packet loss tolerance.

18. The method of claim 15, wherein periodically measuring the network parameters comprises:
determining multiple average values for each of the network parameters, each average value corresponding to a different time period; and
calculating mean value of the multiple average values for the network parameter.

19. The method of claim 18, wherein determining multiple average value comprises:
obtaining a set of readings for the network parameter during a predetermined time period;
assigning varied weightage for each of the readings of the network parameter; and
determining average value of the network parameter.

20. The method of claim 13, further comprising:
periodically reporting the network characteristics to at least one of the utility computing server and the network computer.

21. The method of claim 13, further comprising:
periodically reporting the list of eligible cloud based utility services to the network computer.

22. The method of claim 21, further comprising:
filtering the list of eligible cloud based utility services based on the time of reporting.

23. The method of claim 13, further comprising:
dynamically configuring the utility computing server to control periodicity of measurement of the network characteristics.

24. A system for providing one or more additional resources in a utility computing environment, the system comprising:
a storage medium comprising:
a secured partition configured for storing at least one utility computing environment resource;
an unsecured partition configured for storing at least one user desired operating system and at least one user desired resource; and
an execution abstraction layer configured for enabling a user to switch between the utility computing environment and the user desired operating system.

25. The system of claim 24, wherein the utility computing environment is configured to control access to the unsecured partition.

26. The system of claim 24, wherein the unsecured partition is configured to be accessed using universal serial bus.

27. A system for providing one or more additional user resources in a utility computing environment, the system comprising:
a first storage device configured for storing at least one utility computing environment resource;
a second storage device configured for storing at least one user desired operating system and at least one user desired resource; and
an execution abstraction layer configured for enabling a user to switch between the utility computing environment and the user desired operating system.

28. The system of claim 27, wherein the utility computing environment is configured to control access to the second storage device.

29. The system of claim 27, wherein the second storage device is configured to be accessed using universal serial bus.
